(19) United States
(12) Patent Application Publication
(10) Pub. No.: US 2006/0143074 A1
(43) Pub. Date: Jun. 29, 2006

(54) Vender evaluation method

(76) Inventors: Tien-Chieh Wu, Taipei City (TW); Jia-Shyang Chou, Hsinchu City (TW)

Correspondence Address: RABIN & Berdo, PC, 1101 14TH STREET, NW, SUITE 500, WASHINGTON, DC, 20005, US

(21) Appl. No.: 11/315,297

(22) Filed: Dec. 23, 2005

(30) Foreign Application Priority Data
Dec. 27, 2004 (TW) 93140746

(51) Int. Cl. G06F 11/34

(52) U.S. Cl. 705/11

(57) ABSTRACT

A vender evaluation method is provided, which is used to enable the control and management department responsible for controlling evaluation procedures to authorize an evaluation staff to enter evaluation data into a digitalized vender evaluation form by making use of an application server and an evaluation staff list. A vender evaluation report is generated that indicates the service quality of the vender, based on the evaluation data in the digitalized vender evaluation form. As such, the execution of vender evaluation can be completed speedily without being affected by the distance between the control and management department and the various evaluation departments.

### CROSS-REFERENCE TO RELATED APPLICATIONS

This non-provisional application claims priority under 35 U.S.C. § 119(a) on Patent Application No(s). 93140746 filed in Taiwan, R.O.C. on Dec. 27, 2004, the entire contents of which are hereby incorporated by reference.

### BACKGROUND OF THE INVENTION

1. Field of the Invention

The invention relates to a vender evaluation method, and in particular to a vender evaluation method that can be utilized to designate the evaluation staff through a network so that the evaluation staff can execute evaluation simultaneously.

2. Related Art

Due to the ever expanding business scope of modern enterprises, it is essential that enterprises are in close cooperation with their various venders, thus raising businesses' competitiveness and satisfy the demands of their customers. In this manner, enterprises may be able to create and keep their competitive edge and maintain their continued successful operations.

The service quality provided by the venders will not only affect the quality and speed of the enterprise's production, but may also affect the quality of service rendered by the enterprise to its customers. Therefore, the enterprise may significantly raise its competitiveness by evaluating the performance of the venders so as to control the service quality of the venders and replace incompetent venders quickly.

Please refer to FIG. 1, which shows a schematic diagram illustrating the operation of the vender evaluation method of the prior art. As shown in FIG. 1, the vender evaluation of the prior art is done manually by the control and management department 2 via paperwork by sequentially transmitting the vender evaluation forms to the evaluation staff (for example, the managers of the respective departments) of the designated departments (for example, material reception department 4, procurement department 6, finance & accounting department 8, and research and development department 10, etc.), so that the evaluation staff can fill in the evaluation data required in the vender evaluation form. Then, the various filled-in vender evaluation forms are gathered and compiled by the control & management department 2 to produce the vender evaluation report. This process of gathering, compiling and preparation of vender evaluation reports is done manually by the staff of the control & management department 2.

The abovementioned method causes inconvenience and waste of time. For example, the evaluation staff of the respective departments in charge of the evaluation are often enable to complete the vender evaluation forms in time, so the staff of the control and management department 2 wastes time inquiring about the completion of the vender evaluation forms from the various departments. Moreover, since the vender evaluation forms are transmitted in a paperwork manner, any slight negligence of the evaluation staff may cause loss of the vender evaluation forms.

Besides, nowadays the various departments of many enterprises are scattered all over the world, and since the conventional evaluation method is not suitable for long distance evaluation, the evaluation departments do not include all the departments of the enterprise, thus leading to errors or deviations in the vender evaluation report. In addition, since the vender evaluation report is transmitted through the various departments in sequence, the fear that their evaluation data may be disclosed leads to the evaluation staff taking a reserved attitude toward the data they fill in the vender evaluation form, which in turn results in inaccurate data.

Moreover, in the prior art, staff evaluation is performed by the managers of the various departments, yet in actuality, the various managers may not be able to be in direct contact with the venders. As such, they are not capable of understanding for certain the exact service quality of the vender, so evaluation data they provide may not be accurate.

Therefore, various enterprises seek a more expedient and efficient way to evaluate venders, so they can understand and control the service quality of their venders.

### SUMMARY OF THE INVENTION

The object of the invention is to provide a vender evaluation method to solve the above-mentioned problem. Its major function is to enable the control and management department in charge of vender evaluation to authorize evaluation staff via a network, and provide an environment (for example, digitalized evaluation forms) in which the evaluation staff is able to complete the vender evaluation form simultaneously, thus expediting vender evaluation.

The method of vender evaluation according to the invention comprises the following steps: first, generating a list of evaluation staff according to dispatching instructions; then, authorizing evaluation staff appearing on the list to fill in the evaluation data in the digitized vender evaluation forms; next, transmitting the blank digitized vender evaluation forms to the various evaluation staff to fill in the related evaluation data; then, receiving and gathering the completed vender evaluation forms from the various evaluation staff; and finally, generating the vender evaluation reports based on the evaluation data contained in the completed vender evaluation forms.

Further scope of the applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a schematic diagram illustrating the operation of the vender evaluation method of the prior art;

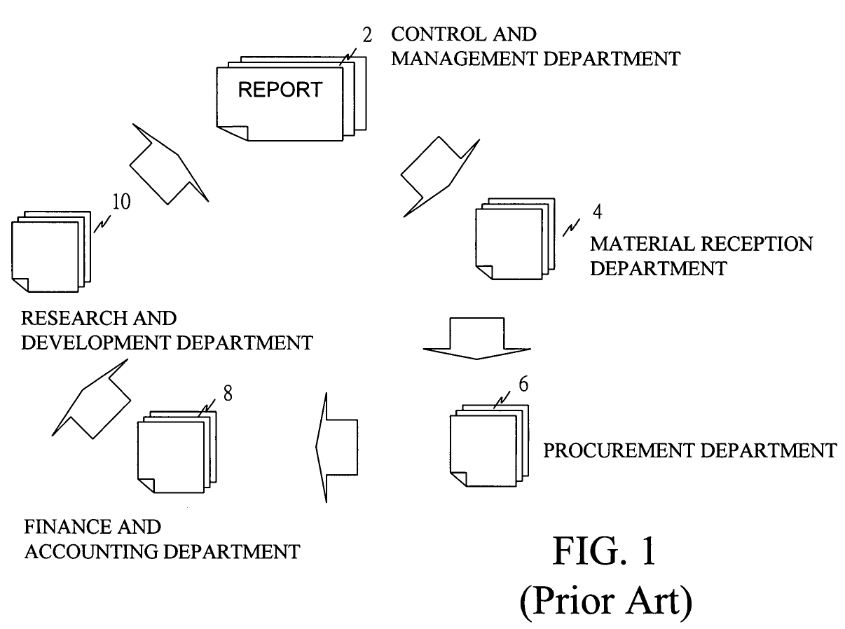

FIG. 2 is a schematic diagram illustrating the operation of the vender evaluation method according to the first embodiment of the invention;

FIG. 3 is a flowchart illustrating the vender evaluation method according to the first embodiment of the invention;

FIG. 4 is a schematic diagram for the interface of the vender evaluation result according to the first embodiment of the invention;

FIG. 5 is a flowchart of the method of generating the vender evaluation report according to the first embodiment of the invention;

FIG. 6 is a schematic diagram for the interface of the vender evaluation report;

FIG. 7 is a flowchart of the method of generating the sorted vender evaluation report according to the first embodiment of the invention; and

FIG. 8 is a schematic diagram for the interface of the sorted vender evaluation report.

### DETAILED DESCRIPTION OF THE INVENTION

The purpose, construction, features, and functions of the invention can be appreciated and understood further through the following detailed description with reference to the attached drawings.

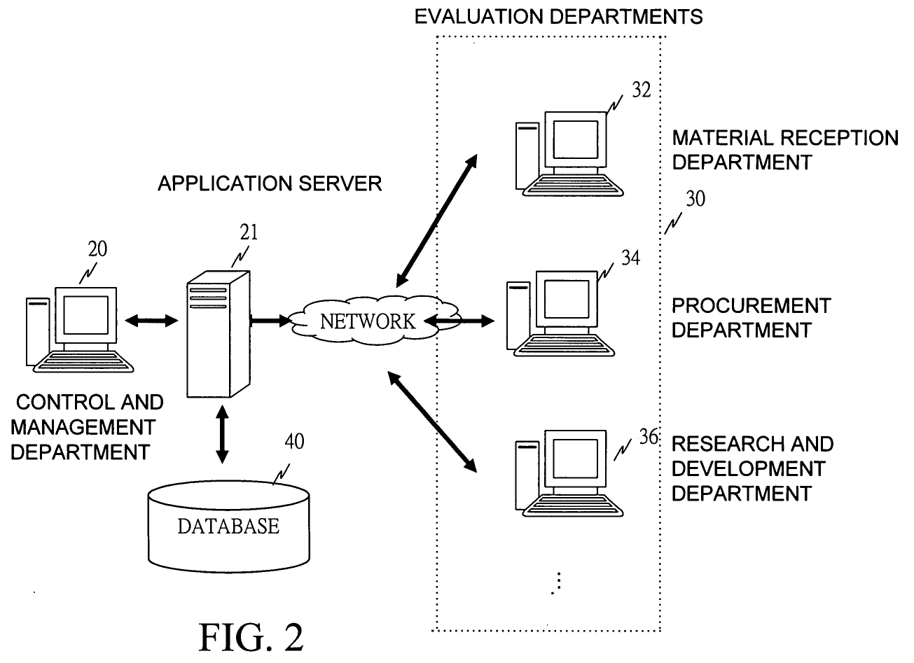

Refer to FIG. 2, which is the schematic diagram illustrating the operation of the vender evaluation method according to the first embodiment of the invention. As shown in FIG. 2, the control and management department 20 is used to send a dispatching instruction to the application server 21 for generating an evaluation staff list, allowing the application server 21 to delegate authority to the staff of the respective evaluation departments 30 (for example, the material reception department 32, the procurement department 34, and the research and development department 36, etc.) and allowing them to enter the evaluation data into the digitized vender evaluation form, which is transmitted back into the application server 21 via a network upon completion by the evaluation staff. The application server 21 is used to generate a vender evaluation report based on the completed evaluation form, so that the evaluation data sent back by the evaluation staff is shown in the evaluation report. In addition, the control and management department 20 may direct the application server 21 through evaluation instructions or sorting instructions to generate the vender evaluation report or the sorted vender evaluation report. The vender evaluation report is used to indicate venders' average score data regarding the respective evaluation item; while the sorted vender evaluation report is used to indicate the venders' score data sorted according to the venders' average scores concerning a specific evaluation item, as based on the vender evaluation data and the sorted data in data base 40.

In the above discussion, the control and management department 20 is the department in charge (for example, the quality assurance department), and is responsible for the control and management of the vender evaluation procedure of the enterprise. The application server 21 is used to execute the computer system, the application programs located at the control and management department 20, or the location that can be connected to the control and management department 20 via a network. The various evaluation departments 30 are qualified to execute the evaluation, and are connected to the application server 21 through a network. The data base 40 is capable of operating on the application server 21, or is a stand-alone data base server connected to the appropriate server 21 via a network to produce the sorted vender evaluation report. The data base 40 may be the Data Base Management System (DBMS) having security control and management capabilities.

The above-mentioned evaluation staff list is stored in the application server 21 or data base 40, which is used to record the data concerning the evaluation staff in the various evaluation departments 30 having evaluation qualification, the data concerning the various evaluation cases already done, and data concerning the evaluation cases currently being conducting.

Furthermore, the digitized vender evaluation form is stored in the application server 21 or the data base 40, and its contents can be varied depending on the evaluation data to be filled in by the evaluation staff of the various evaluation departments 30, and which can be in digitized form (for example, e-mail, signed digitalized document or web-base interface) transmitted through the network.

The contents of the evaluation data are the score data (for example, price bargain score data, quality score data, technical capability score data, return material authorization (RMA) score data) given by the evaluation staff concerning the various evaluation items (for example, price bargain, quality, technical capability, return material authorization (RMA), etc.) as shown in the vender evaluation form.

The sorted data is utilized to indicate the vender score data sorted according to the various average scores concerning the various evaluation items. Moreover, a new vender's average score data can be added to the sorted data and resorted to generate newly sorted data. The above-mentioned venders' average score data is derived from the average of the scores of the same vender given by the various evaluation staff concerning the same evaluation item.

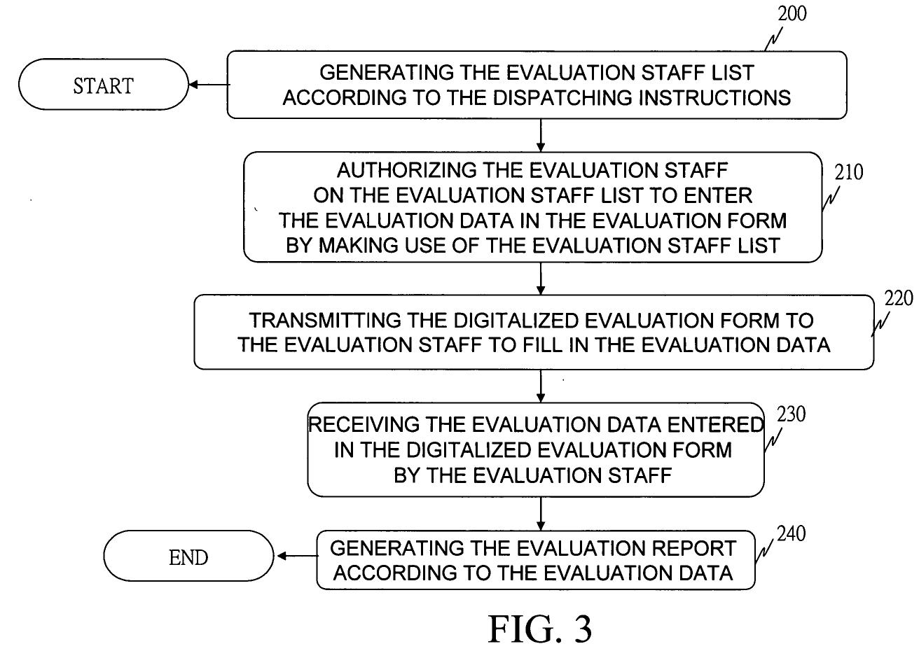

For more detailed description of the vender evaluation process, please refer to FIG. 3, which is a flowchart illustrating the vender evaluation method according to the first embodiment of the invention, comprising the following steps:

Firstly, generating an evaluation staff list according to the dispatching instructions (step 200); the control and management department 20 may direct the various evaluation departments 30 to select the appropriate evaluation staff, and add them to the evaluation staff list through the dispatching instruction; then authorizing the evaluation staff in the evaluation staff list to fill the evaluation data into the digitized vender evaluation form (step 210); subsequently, transmitting the digitized vender evaluation form to the evaluation staff for filling in the form (step 220); then receiving the completed evaluation form as sent back by the evaluation staff (step 230); and finally, generating the vender evaluation report based on the completed evaluation form (step 240).

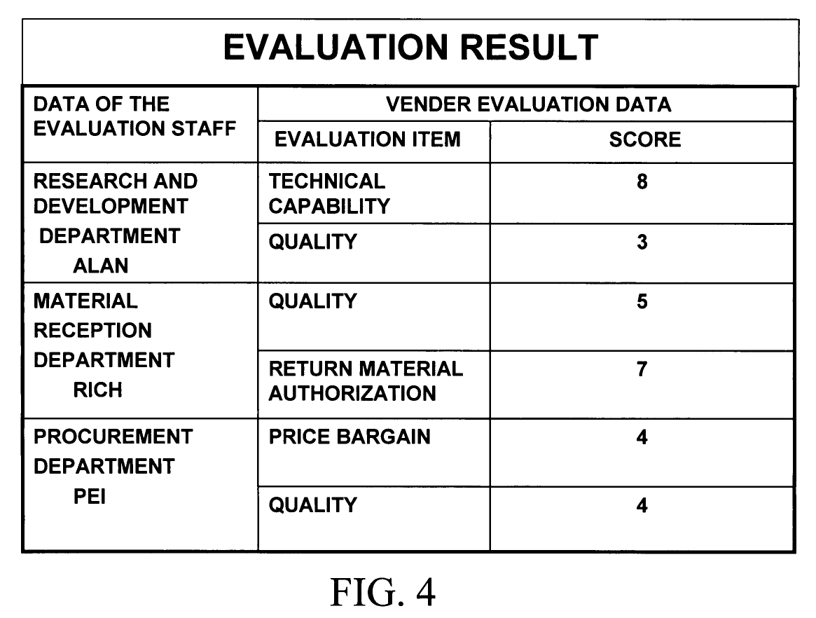

Next, refer to FIG. 4, which is a schematic diagram of the interface of the vender evaluation result according to the first embodiment of the invention. As shown in FIG. 4, the vender evaluation result is obtained by compiling and consolidating the completed score data given by the evaluation staff concerning the particular evaluation item.

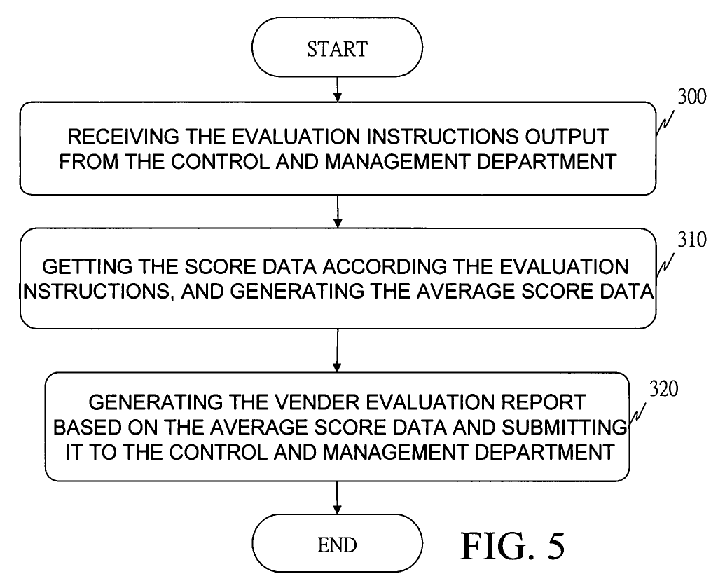

FIG. 5 is a flowchart of the method of generating the vender evaluation report according to the first embodiment of the invention. This method is used to generate a vender evaluation report based on the evaluation data in the vender evaluation form. The steps of this drawing must follow step 230 (receiving the evaluation data in the vender evaluation form from the evaluation staff) of FIG. 3 of the first embodiment. As shown in FIG. 5, it mainly comprises the following steps: firstly, receiving the evaluation instructions from the control and management department (step 300); then, retrieving the respective score data according to the evaluation instructions, and generating the average score data (step 310); and finally, generating the vender evaluation report based on the average score data and submitting it to the control and management department (step 320).

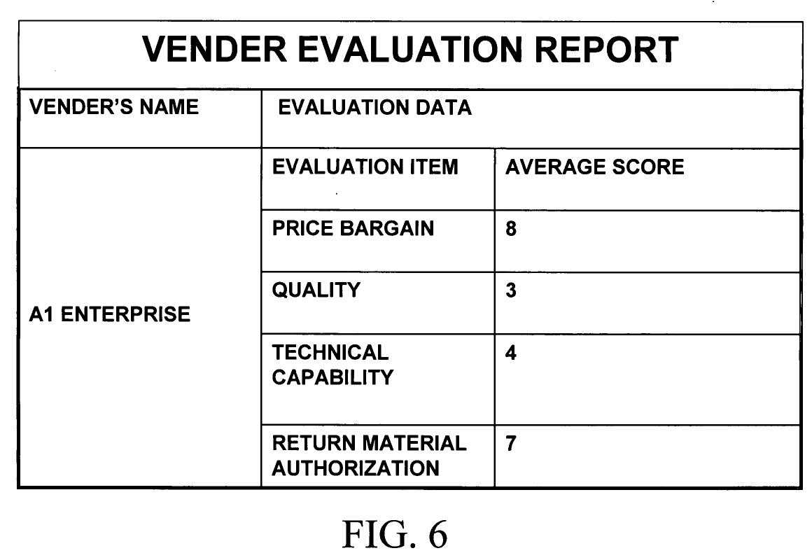

FIG. 6 is a schematic diagram for the interface of the vender evaluation report, which shows the average score data of the various evaluation items for a particular vender.

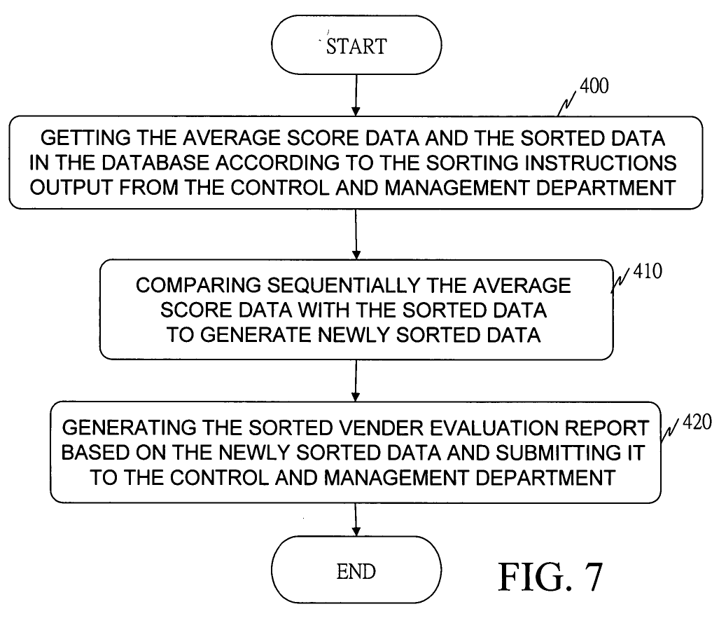

FIG. 7 is a flowchart of the method of generating the sorted vender evaluation report according to the first embodiment of the invention. This method is used to generate a vender evaluation report sorted according to the average score data regarding the same evaluation item for the various venders. As shown in FIG. 7, it mainly comprises the following steps.

The steps of this drawing must follow step 310 (generating the average score data) of FIG. 5, then it continues with the following steps:

Firstly, getting the average score data of a particular evaluation item and the sorted data in the database according to the sorting instructions output from the control and management department (step 400); then, sequentially comparing the average score data with the sorted data, thus generating newly sorted data (step 410), which is obtained by comparing the average score data with the sorted score data, and adding the score data into the sorted data to generate newly sorted data. For example, the score data in the sorted data are 10 and 7 respectively, while the score data is 8, then the newly sorted data are 10, 8 and 7; and finally, generating the sorted vender evaluation report based on the newly sorted data and submitting it to the control and management department (step 420).

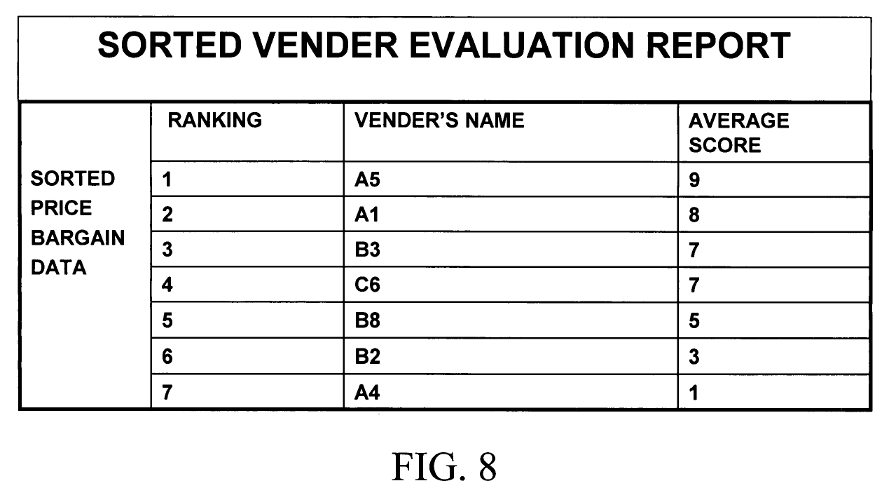

FIG. 8 is the schematic diagram for the interface of the sorted vender evaluation report, which shows the sorted vender evaluation report as sorted by the average score data concerning the same particular evaluation item for the various venders.

As mentioned above, the method provided by the invention can not only enable the various departments of the enterprise to participate in the evaluation, but the control and management department can also obtain precise and accurate evaluation data, and is thus able to provide the various vender evaluation reports having multi-sorting features depending on the actual requirements of the various departments.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A vender evaluation method, comprising the following steps:
generating an evaluation staff list according to a dispatching instruction;
authorizing more than one evaluation staff on the evaluation staff list to fill the evaluation data in the digitalized vender evaluation form;
transmitting said digitalized vender evaluation form to said staff to fill in the evaluation data;
receiving the evaluation data filled in said digitized vender evaluation form by said evaluation staff; and
generating the evaluation report based on said evaluation data.

2. The vender evaluation method as claimed in claim 1, wherein said evaluation staff list is used to indicate the data of said evaluation staff who has not yet received said digitalized vender evaluation form.

3. The vender evaluation method as claimed in claim 1, wherein said digitalized vender evaluation form is transmitted to said evaluation staff via e-mail.

4. The vender evaluation method as claimed in claim 1, wherein said digitized vender evaluation form is transmitted to said evaluation staff via digitalized signed document.

5. The vender evaluation method as claimed in claim 1, wherein said digitized vender evaluation form is transmitted to said evaluation staff via web-based interface.

6. The vender evaluation method as claimed in claim 1, wherein said evaluation data comprises at least a score data.

7. The vender evaluation method as claimed in claim 6, wherein said score data can be selected from one of the following comprising the group of: price bargain score data, quality score data, technical capability score data, and return material authorization (RMA) score data.

8. The vender evaluation method as claimed in claim 1, wherein said step of receiving said evaluation data step, further comprising the steps of:
receiving the evaluation instruction from said control and management department;
fetching said respective score data according to said evaluation instruction, and generating the average score data; and
generating the venders evaluation report and submitting it to the control and management department.

9. The vender evaluation method as claimed in claim 8, wherein said average score data is the average of said respective score data.

10. The vender evaluation method as claimed in claim 8, wherein said step of generating said average score data, further comprising the steps of:
fetching said average score data and the sorted data in the data base according to the sort instruction output from said control and management department;
comparing said average score data with said sorted data sequentially, and generating the newly sorted data; and
generating a sorted vender evaluation report based on said newly sorted data, and submitting it to the control and management department.
